(19) United States
(12) Patent Application Publication
(10) Pub. No.: US 2011/0077079 A1
(43) Pub. Date: Mar. 31, 2011

(54) METHOD FOR RHYTHM ACTION GAME USING TERMINAL OPERATED WITH KEYPAD, AND RECORDING MEDIUM WITH PROGRAMME CAPABLE OF RUNNING SAID GAME RECORDED THEREON

(75) Inventors: Jang Cheon Ahn, Seoul (KR); Dong Wan Choi, Incheon (KR)

(73) Assignee: ANBSOFT CO., LTD., Seoul (KR)

(21) Appl. No.: 12/996,084

(22) PCT Filed: Apr. 15, 2009
(86) PCT No.: PCT/KR2009/001934

§ 371 Date: Dec. 3, 2010

(30) Foreign Application Priority Data
Jun. 4, 2008 (KR) 10-2008-0052591

(51) Int. Cl. A63F 13/00

(52) U.S. Cl. 463/31

(57) ABSTRACT

The present invention relates to a rhythm action game, and, more particularly, a rhythm action game using a terminal equipped with a keypad. Using the rhythm action game described in the present invention, a user selects the number of keys that are used to hit note images while playing the game, so that a game mode is determined, and thus the difficulty level of the game can be determined. Further, the present invention notifies the user who is playing the game of the results of note-based games, not only using images, but also using vibrations. Further, the present invention provides sync information for respective types of terminals, thus enabling the play of music to be synchronized with the output of images.

### TECHNICAL FIELD

The present invention relates, in general, to rhythm action games, and, more particularly, to a rhythm action game method using a terminal equipped with a keypad and a recording medium for storing a rhythm action game using the terminal equipped with a keypad in the form of an executable program.

### BACKGROUND ART

The basis of technologies that enable game programs to be executed by various types of terminals, including mobile terminals, and games to be played has been provided. These technologies have been provided in a variety of forms ranging from a technology which receives and executes game programs on the basis of a wired or wireless network, to a technology which receives game programs in the form of files on the basis of a wired or wireless network and stores and executes the game programs, and to a technology which executes game programs stored in storage media such as optical recording devices. However, mobile terminals have lower hardware performance and lower software and logic performance related to sound power than do high-specification devices such as personal computers. Accordingly, in order to play games on mobile terminals, games must be configured using methods suitable for the instrumental characteristics or the use environment of the mobile terminals.

### DISCLOSURE

### Technical Problem

The present invention has been made keeping in mind the above prior art, and a technical object of the present invention is to provide a rhythm action game method using a terminal equipped with a keypad and a recording medium for storing the rhythm action game method in the form of an executable program.

### Technical Solution

In accordance with an aspect of the present invention to accomplish the above object, there is provided a rhythm action game method using a terminal equipped with a keypad, including the steps of receiving key selection information required to determine a type and a number of keys that are used when a game is executed and music selection information required to select music that is output when the game is executed, outputting note images through a display unit of the terminal, together with the selected music, according to a note-falling pattern that is determined based on the key selection information and the music selection information, receiving information about user responses to the note images input by a user through the keypad, judging results of note-based games using the user response information, and outputting the results of the note-based games to the terminal in a form of one or more of images and vibrations.

In accordance with another aspect of the present invention, there is provided a recording medium for storing a rhythm action game method using a terminal equipped with a keypad in a form of an executable program, wherein the game method includes the steps of receiving key selection information required to determine a type and a number of keys that are used when a game is executed and music selection information required to select music that is output when the game is executed, outputting note images through a display unit of the terminal, together with the selected music, according to a note-falling pattern that is determined based on the key selection information and the music selection information, receiving information about user responses to the note images input by a user through the keypad, judging results of note-based games using the user response information, and outputting the results of the note-based games to the terminal in a form of one or more of images and vibrations.

In the above two aspects, the game method may further include a synchronization step of acquiring synchronization (sync) information related to the terminal, and synchronizing output of the note images with output of the music using the sync information.

The synchronization step may be performed in a procedure for initially setting a program for executing the game method. Further, the synchronization step may be performed depending on settings made by the user.

In this case, the sync information may include information about time it takes sound data to be loaded into a sound chip in the terminal and information about speed at which music is played by the sound chip in the terminal.

The results of the note-based games may be determined based on one or more of accuracy, speed and time of the user response.

The note images may be output together with one of key information related to the note images and specific note image information.

The note images may include a normal note and a long note.

The note images may be output at a speed of 10 to 20 frames per sec.

The game method may further include the step of receiving option selection information related to one or more of a plurality of option selection items which include a speed option and a note arrangement option, wherein the option selection items may be determined depending on points acquired in relation to notes output together with a specific note image while the user is playing the game.

### Advantageous Effects

According to the present invention, a rhythm action game can be executed using a terminal equipped with a keypad.

In particular, according to the present invention, relationships between the setting of keys and the difficulty levels of the game are assigned, and thus a rhythm action game having a key setting method optimized for the keypad of a mobile terminal can be provided.

Further, according to the present invention, the problem of the execution speeds of games slightly differing among terminals depending on the hardware or internal software versions, or the frequencies with which or the methods whereby users use mobile phones, can be mitigated thanks to a synchronization function.

Furthermore, according to the present invention, a game user's feeling of hitting can be improved by introducing a vibration mode that can be implemented in mobile terminals.

Furthermore, according to the present invention, note images are output at a high frame speed to allow a user to feel the continuity of a game, and judgment criteria for the results of note-based games can be subdivided to promote pleasure while playing the games.

Furthermore, according to the present invention, a user can select his or her desired music in addition to pieces of music stored in a game program and can play the game using more pieces of music, by using a download system.

### DESCRIPTION OF DRAWINGS

FIG. 1 is a block diagram showing the construction of an exemplary terminal equipped with a keypad and capable of executing a rhythm action game according to an embodiment of the present invention;

FIG. 2 is a flowchart showing a method of executing a rhythm action game using the terminal equipped with a keypad according to an embodiment of the present invention;

FIG. 3 illustrates game screens showing the method of executing a rhythm action game using the terminal equipped with a keypad according to an embodiment of the present invention;

FIG. 4 is a diagram showing the construction of an exemplary keypad of the terminal capable of executing a rhythm action game according to an embodiment of the present invention;

FIG. 5 illustrates game screens showing a relationship between the keypad and the setting of difficulty levels in the method of executing a rhythm action game using the terminal equipped with a keypad according to an embodiment of the present invention;

FIG. 6 illustrates game screens showing the types of note images in the method of executing a rhythm action game using the terminal equipped with a keypad according to an embodiment of the present invention;

FIG. 7 is a flowchart showing a method of synchronizing sound with note images in the method of executing a rhythm action game using the terminal equipped with a keypad according to an embodiment of the present invention; and

FIG. 8 illustrates game screens showing a method in which a user synchronizes sound with note images in the method of executing a rhythm action game using the terminal equipped with a keypad according to an embodiment of the present invention.

### BEST MODE

The present invention relates to a rhythm action game, which refers to a game for hitting falling notes on the screen in time to sound that is being listened to. It is apparent that detailed contents for implementing the present invention, which will be described later, are not limited to the terms of a rhythm action game, and can be applied to the case where those terms are replaced by various terms such as those applicable to rhythm games, music pattern games, or music link games.

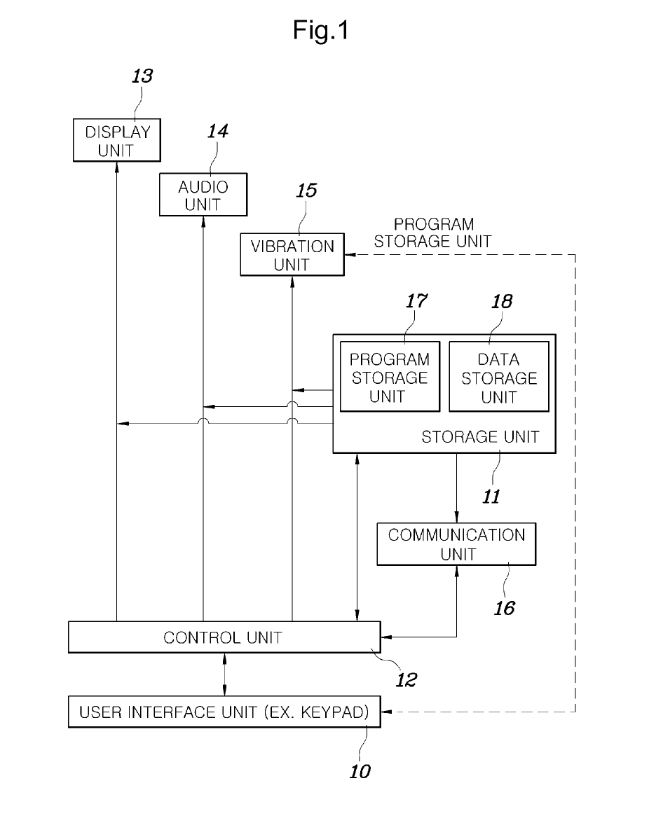

FIG. 1 is a block diagram showing the construction of an exemplary user terminal equipped with a keypad and capable of executing a rhythm action game according to an embodiment of the present invention.

Referring to FIG. 1, the terminal may include a user interface unit 10, a storage unit 11, a control unit 12, a display unit 13, an audio unit 14, and a vibration unit 15, and may further include a communication unit 16.

The user interface unit 10 is provided to allow a user to manipulate the terminal, and may be, for example, a keypad. Using the user interface unit 10, the user may make settings, required to execute the rhythm action game according to the present invention, and may enter user response information.

The storage unit 11 may include a program storage unit 17 and a data storage unit 18. The program storage unit 17 may store programs for controlling typical operations of the user terminal, rhythm action game programs according to the present invention, and programs for controlling the execution of the rhythm action game. Further, the data storage unit 18 may store typical data required to execute the above programs, for example, music files or image files, each including information about at least one rhythm action game according to the present invention. Further, the data storage unit 18 may temporarily store data generated during the execution of the above programs.

The control unit 12 performs the function of controlling the overall operation of the terminal. For example, the control unit 12 can generate control signals required to execute the programs stored in the program storage unit 17, or to output the data stored in the data storage unit 18 through the display unit 13 or the like, on the basis of the user input information that has been input through the user interface unit 10, and can transmit the control signals to relevant components. Further, the control unit 12 can perform control required to execute the rhythm action game, such as by collecting user responses that are being input during the execution of the rhythm action game according to the present invention and by judging and calculating the results of the game.

The display unit 13 displays video or image signals output from the storage unit 11 on the screen or displays user data output from the control unit 12, in response to control signals from the control unit 12. Here, the display unit 13 may be implemented using a Liquid Crystal Display (LCD). In this case, the display unit 13 may include an LCD controller, a storage unit for storing video data, an LCD device, etc. Further, when the display is implemented in the form of a touch screen, the keypad is implemented on the screen and may function as the above-described user interface unit 10.

The audio unit 14 outputs music signals output from the storage unit 11 in response to the control signals from the control unit 12. The audio unit 14 may output music during the execution of the rhythm action game according to the embodiment of the present invention.

The vibration unit 15 generates vibrations depending on one or more vibration patterns in response to a control signal from the control unit 12. For example, the vibration unit 15 is configured to include a motor, so that when a control signal requesting the generation of vibrations is received, the motor is operated in response to the control signal, thus causing vibrations on the terminal. Various vibration patterns may be configured by differently setting the vibration strength, the length of a rhythm, etc.

Meanwhile, the communication unit 16 may be provided to perform the wireless communication function of the terminal. The communication unit 16 may include a Radio Frequency (RF) transmitter for up-converting the frequency of a transmission signal and amplifying a resulting transmission signal, an RF receiver for low-noise amplifying a received signal and down-converting the frequency of the received signal, and a MOdulator-DEModulator (MODEM) for encoding and modulating transmission or reception signals.

The terminal may download required music and note-falling patterns for the music from the network via the communication unit 16, may use the music and the note-falling patterns during the execution of the game, and may also share the execution results of the game among users to check the ranking among the users. The ranking may include various ranking categories such as personal ranking and school ranking.

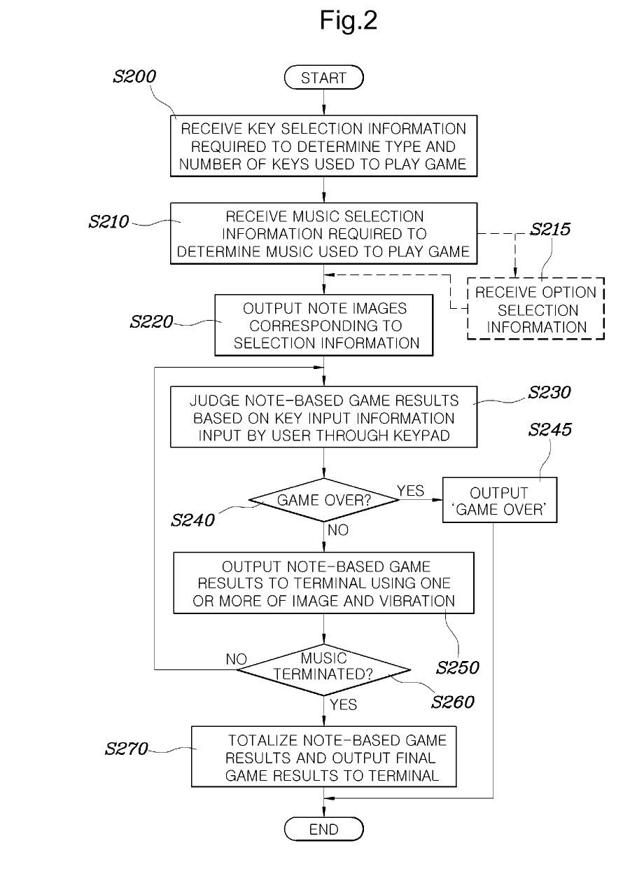

FIG. 2 is a flowchart showing a method of executing a rhythm action game using a terminal equipped with a keypad according to an embodiment of the present invention.

First, at step S200, the terminal inputs key selection information from the user via the user interface unit 10, for example, a keypad. Here, the term ‘key selection information’ refers to information required to determine the type and/or the number of keys that are used to hit note images and/or the number of keys while the user is playing the rhythm action game according to the present embodiment. Here, it is apparent that the keypad also includes a keypad implemented on a display configured as a touch screen.

For example, it is assumed that key selection modes are defined as three types of modes. First mode is set to a mode for selecting keys 1, 2, and 3, second mode is set to a mode for selecting keys 1, 2, 3, 4, 5, and 6, and third mode is set to a mode for selecting keys 1, 2, 3, 4, 5, 6, 7, 8, and 9, and thus keys can be selected using a method of selecting one from among the above three modes.

The selection of keys at step S200 according to the present embodiment may be regarded as the selection of the difficulty level of the game. When the difficulty level of the game is set such that as the number of keys that are used to play the game increases, the difficulty level of the game increases, note-falling patterns displayed on the screen while the user is playing the game are implemented to become further complicated as the number of keys increases, thus allowing the user to play a game having a higher difficulty level. Here, the term ‘note-falling pattern’ defines a form in which individual notes are falling on the screen of the display unit 13.

For example, in the example of the above-described key selection mode setting, the first mode in which three keys are used is set to EASY mode in which the game can be configured in a difficulty level at which any beginner of a rhythm action game can easily play the game. Further, the second mode in which six keys are used is set to HARD mode in which the game can be configured in a difficulty level at which a user accustomed to the rhythm action game can play the game. Finally, the third mode in which nine keys are used is set to CRAZY mode in which the game can be configured in a high difficulty level at which all keys on the keypad are used and which can create in a user experienced in the rhythm action game the desire to make a challenge.

In this case, the total number of key selection modes, the names of the difficulty levels for the respective modes, the numbers of keys used in the respective modes, the types of keys used in the respective modes, etc., are not limited to the above examples, and can be freely set using various methods.

Further, at step S210, the terminal inputs music selection information from the user via the user interface unit 10, for example, a keypad. In this case, pieces of music that can be selected are displayed on the screen of the display unit 13, and the pieces of selectable music may include basically stored music, music downloaded via network communication, etc.

At step S220, the terminal displays note images, corresponding to note-falling patterns related to key selection information selected at step S200 and the music selection information selected at step S210 on the basis of the key selection and music selection information, on the screen through the display unit 13. When the note images are displayed on the screen, the terminal outputs the music selected at step S21, together with the note images, through the audio unit 14. It is preferable to continuously output music and note images corresponding thereto regardless of the results of the notes-based games of users.

When note images are displayed on the screen while the game is being executed, they are output at a high speed of 10 to 20 frames per sec in the present embodiment. The note images are output at high speed, so that there are advantages in that the users can continuously monitor the falling of the note images and in that the judgment of the play of note-based games by the users can be implemented in various levels. Such a note-based game play may also be called ‘note hit’.

Each user can play the game by entering the user responses to music and the note images, displayed on the screen of the display unit 13, through the keypad.

At step S230, the terminal judges the results of note-based games on the basis of the user responses entered through the keypad. The results of note-based games may be determined based on one or more of the accuracy, speed and time of the user responses. The results of the judgment based on the results of the note-based games may be displayed on the screen to allow the user to check the results while playing the games, and may be stored and used to determine the final score.

The note-based game results may be judged by measuring, for example, a time interval between the specific time point at which each note image is falling and the time point at which the user's response to the note image is made. This may be determined using the difference in distance, for example, a pixel interval, between the location of a note in a frame in which the note image is aligned with a specific falling reference line and the location of a note in a frame in which the user's response is entered. As the difference in the distance becomes smaller, a high score is assigned. When the difference in distance becomes greater than a preset threshold, a relevant note is judged not to have been hit.

The following Table 1 shows an example in which note-based game results are defined based on five types of judgment criteria.

TABLE 1

| judgment | Description |
|---|---|
| Perfect | When note image is accurately aligned with reference line |
| Great | When note image is spaced apart from reference line by |
| | interval of 0~5 pixels |
| Good | When note image is spaced apart from reference line by |
| | interval of 6~10 pixels |
| Bad | When note image is spaced apart from reference line by |
| | interval of 11~15 pixels |
| Miss | When note image is spaced apart from reference line by |
| | interval of 16 or more pixels |

Combination (Combo) results indicating the consecutive hits of the user, as well as the note-based game results, can be calculated. Here, “hit” may be determined such that the results of the note-based game play by the user may be one of Perfect, Great, Good and Bad if the judgment criteria of Table 1 are used. Further, combo bonus grades are defined according to the number of consecutive hits, so that the scores of the note-based games based on consecutive hits can be increased for individual bonus grades. Further, these combo results may be taken into consideration together with the note-based game results when the final game results are subsequently calculated.

The following Table 2 shows an example in which respective combo bonus grades corresponding to the numbers of consecutive hits are defined.

TABLE 2

| Combo bonus | Number of consecutive hits |
|---|---|
| x1 | 0~19 |
| x2 | 20~29 |
| x3 | 30~39 |
| x4 | 40~49 |
| X5 | 50 or more |

Referring to Table 2, the results of note-based games corresponding to the numbers of consecutive hits are shown in such a way that when the number of consecutive is 0˜19, score per hit assigned to each judgment grade equally increases, when the number of consecutive hits is 20˜29, the score per hit increases twice, and when the number of consecutive hits is 30˜39, the score per hit increases three times. Further, similarly, when the number of consecutive hits is 40˜49, the score per hit increases four times, and when the number of consecutive hits is 50 or more, the score per hit increases five times.

At step S240, the results of the note-based games are accumulated, and whether the game results correspond to preset game-over criteria is determined. As a result of the determination, if the game results correspond to the game-over criteria, ‘game over’ is displayed on the screen at step S245, and the game is terminated.

As the criteria for determining the finish of the game, an element called ‘Health Power: HP’ can be used. For example, the terminal may use a method of accumulatively calculating HP values from a basic HP value (for example, 200) using increments/decrements set for judgment grades in relation to the note-based game results determined at step S240, and of determining the game to be finished when the HP value of the user who is playing the game becomes ‘0’.

The following Table 3 shows an example in which increments/decrements set for respective judgment grades in relation to note-based game results are defined, and this indicates an example set based on the judgment criteria defined in Table 1.

TABLE 3

| Judgment | Health Power (HP) |
|---|---|
| Perfect | +6 |
| Great | +3 |
| Good | +1 |
| Bad | 0 |
| Miss | −6 |

When the basic HP value is 200 and increments/decrements defined in Table 3 are used, the HP value of the user, obtained in the situation in which the note-based game results of the user are determined to be ‘miss’ three times and ‘great’ twice, will be 188 which is the result of the accumulative calculation of 200+(−6)*3+3*2.

The game-over determination step at step S240 may be performed on all notes, but may also be performed at preset periods by setting a predetermined period. For example, when the respective notes are output every 10 frames, the game-over determination step may be performed once for more than 10 frames, for example, every 50 frames.

If the note-based game results do not correspond to the game-over criteria as a result of the determination at step S240, notification of the note-based game results is provided to the user in such a way as to display the note-based game results on the screen as images or generate vibrations using the vibration unit 15 at step S250.

When the vibrations are generated by the vibration unit 15, settings may be made such that when the judgment criteria of Table 1 are used, vibrations are generated if the note-based game results correspond to any one of Perfect, Great, Good, and Bad. In this case, when various types of vibrations can be generated, different vibrations may also be output for respective judgment grades. Alternatively, the settings may also be made such that vibrations are generated only when the note-based game results correspond to a specific judgment grade, for example, ‘Perfect’.

This function may be selectively used depending on the settings made by the user. That is, when the user selects vibration mode as “on”, the note-based game results may be output by the vibration unit 15, whereas when the user selects vibration mode as “off”, the note-based game results are output only as images without being output by the vibration unit 15.

Further, depending on whether music has terminated at S260, note-based game results are continuously judged at step S230 if music has not terminated, and the note-based game results are output at step S250.

If music has terminated at step S260, all the note-based game results judged at step S230 are totalized, and the final game results are generated and displayed on the screen through the display unit 13 to notify the user of the game results at step S270, and thereafter the game is terminated.

The final game results are calculated in such a way that the terminal totalizes the note-based game results, and may be displayed in the form of totalized results for respective judgments, a total score, the maximum combo hit, the final grade, etc.

The following Equation 1 shows an example of a method of calculating a total score.

95*N_{Perfect}+80*N_{Great}+65*N_{Good}+N_{Bad}+(−20)*N_{Miss} [Equation 1]

In Equation 1, N_{Perfect} denotes the number of notes judged to be ‘Perfect’, N_{Great} denotes the number of notes judged to be ‘Great’, N_{Good} denotes the number of notes judged to be ‘Good’, N_{Bad} denotes the number of notes judged to be ‘Bad’ and N_{Miss} denotes the number of notes judged to be ‘Miss’. It is possible to additionally consider combo bonus scores corresponding to consecutive hits, together with the method of Equation 1, and thus the total score can be determined.

The final grade may be implemented using various elements required to determine the user's ability to play the game, for example, using a note score that uses results obtained by totalizing the note-based game results for respective judgments and a combo score that uses the combo results.

The following Equation 2 indicates an example of a method of determining a note score.

$$⌊ \frac{\{ \begin{matrix}95 * {N}_{Perfect} + 80 * {N}_{Great} + \\ 65 * {N}_{Good} + {N}_{Bad} + ( - 20 ) * {N}_{Miss}\end{matrix} \}}{{N}_{totalnote}} ⌋ \qquad [ Equation 2 ]$$

In Equation 2, N_{Perfect} denotes the number of notes judged to be ‘Perfect’, N_{Great} denotes the number of notes judged to be ‘Great’, N_{Good} denotes the number of notes judged to be ‘Good’, N_{Bad} denotes the number of notes judged to be ‘Bad’, N_{Miss} denotes the number of notes judged to be ‘Miss’ , and Nₜₒₜₐₗₙₒₜₑ denotes the total number of notes. Further, an operation symbol ‘└ ┘’ is the symbol of a flooring operation, and a flooring operation on real numbers obtains a whole integer minus the decimal portion. That is, the flooring operation calculates the maximum integer smaller than an operation target value, and may exhibit the same results as those obtained when the remainder is omitted from the results of the division operation of Equation 1.

Further, the following Table 4 shows an example of a method of determining a combo score.

TABLE 4

| | Combo percentage | | | |
|---|---|---|---|---|
| | 100% | 70% or more | 30% or more | 29% or less |
| Combo score | 5 | 3 | 1 | −3 |

In table 4, the term ‘combo percentage’ may refer to the ratio of the number of consecutive hits in the maximum combo hit to the total number of hits. The terminal may calculate the ratio of the number of consecutive hits of the user, that is, the number of combo hits, to the total number of notes displayed on the screen when the user is playing the game, and may then determine the combo score, as shown in Table 4.

Then, the final grade can be determined using the score obtained by summing up the above-described note score and combo score, and the following Table 5 shows an example of a method of determining the final grade.

TABLE 5

| | Grade | | | | | | |
|---|---|---|---|---|---|---|---|
| | S | A | B | C | D | E | F |
| Score | 100~96 | 95~91 | 90~81 | 80~76 | 75~71 | 70~1 | 0 |

Referring to Table 5, when the score obtained by summing up a note score and a combo score is 92, the final grade is determined to be ‘A’, and this grade is displayed on the screen as the final grade of the final game results.

When the game is terminated after steps S245 and S270, the process may return to the key selection step or to the music selection step, thus allowing the game to be continuously played.

In the above description, the method of determining scores or the method of determining grades corresponds to an embodiment of the present invention. The rhythm action game described in the present invention is not limited to the above description, and scores and grades can be determined using various methods.

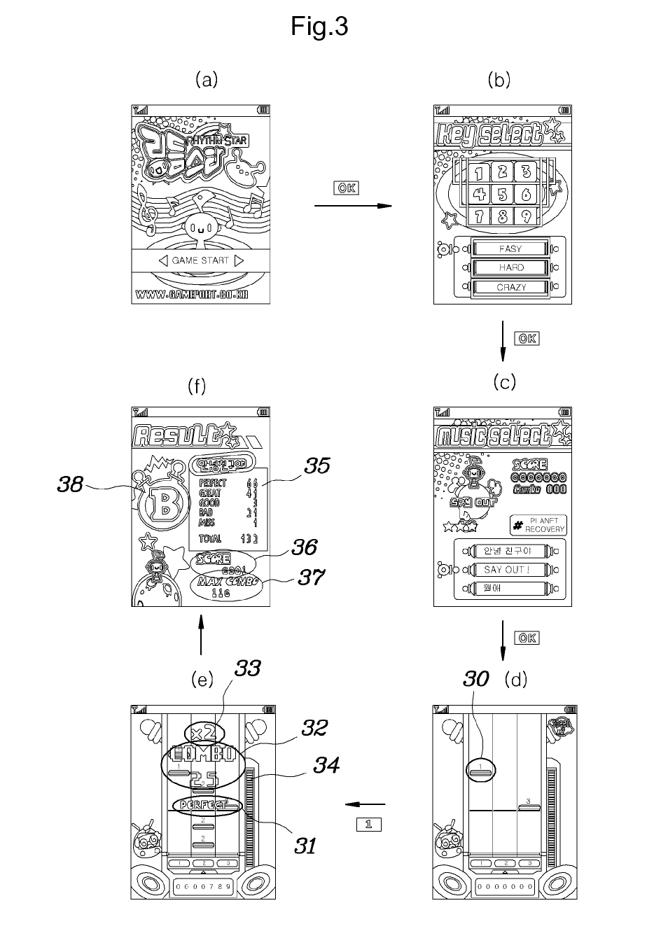

FIG. 3 illustrates screens displayed on the display unit 13 of the terminal in steps in the method of executing a rhythm action game using the terminal equipped with a keypad according to an embodiment of the present invention.

FIG. 3(a) illustrates the screen corresponding to the start step of FIG. 2. When confirmation is input from the user on the screen of FIG. 3(a), the process proceeds to the screen of FIG. 3(b).

FIG. 3(b) illustrates the screen corresponding to the key selection step S200 of FIG. 2. The user can select keys to be used when playing the game through the screen shown in FIG. 3(b). Further, as described above, the user can select the difficulty level of the game by selecting keys. When key selection information is input by the user, the process proceeds to the screen of FIG. 3(c).

FIG. 3(c) illustrates the screen corresponding to the music selection step S210 of FIG. 2. As shown in FIG. 3(c), a plurality of pieces of music are displayed on the music selection screen, thus allowing the user to select desired music from among the plurality of pieces of music displayed on the screen. The plurality of pieces of music may include not only music previously stored when the game program was installed, but also music downloaded by the user over the network or acquired from his or her PC or the like after the installation of the game program. When the music selection information is input by the user, the game is started, and the process proceeds to the screen of FIG. 3(d).

FIG. 3(d) illustrates an initial screen when the game is started. When the game is started, note images 30 are displayed on the screen according to a note-falling pattern which is determined based on both the key selection information and the music selection information input by the user. In this case, the music selected by the user is played through the audio unit 14 at the same time that the game is started.

The game is executed while an operation in which the user selects a key corresponding to each falling note image on the screen and enters a user response through the keypad is repeated. In this case, it is preferable that the music played through the audio unit 14 be continuously played without being influenced by user responses.

FIG. 3(e) illustrates the screen on which the game is being executed. During the execution of the game, the note-based game results 31 of the user, as well as the note images 30 described with reference to FIG. 3(d), are displayed together on the screen. The note-based game results may be determined to be one of a plurality of accuracy levels according to the accuracy of user responses to relevant notes as described above, for example, one of Perfect, Great, Good, Bad, and Miss. Further, in this case, a combo score 32, a bonus grade 33 corresponding thereto, and a user's health power (HP) 34 may also be displayed together on the screen.

As the music is terminated, the game is terminated, and the process proceeds to the screen of FIG. 3(f).

FIG. 3(f) illustrates the screen on which the final game results are displayed when music is terminated and then the game is terminated. The final game results are calculated in such a way that the terminal totalizes note-based game results, and may be displayed in the form of results 35 totalized for respective judgments, the total score 36, the maximum combo hit 37, the final grade 38, etc.

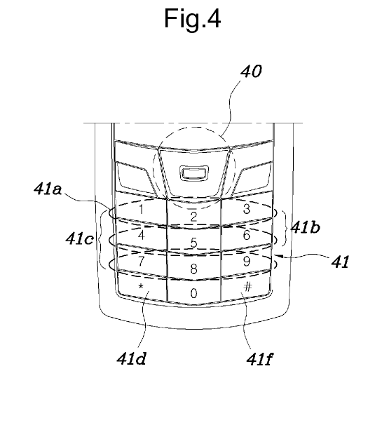

FIG. 4 is a diagram showing the configuration of an exemplary keypad of the terminal capable of executing a rhythm action game according to an embodiment of the present invention.

The functions of respective keys are described as follows by way of the exemplary keypad configuration of FIG. 4. A direction key 40 may be used to move a menu, and numeral keys 41 may be used to enter user responses to note images. In particular, in EASY mode in which three keys are used, keys 1 to 3 (41a) may be used. In HARD mode in which six keys are used, keys 1 to 6 (41b) may be used. In CRAZY mode in which nine keys are used, keys 1 to 9 (41c) may be used. Further, a key * (41d) may be used to go back to the previous page, and a key # (41f) may be used to go to the next page.

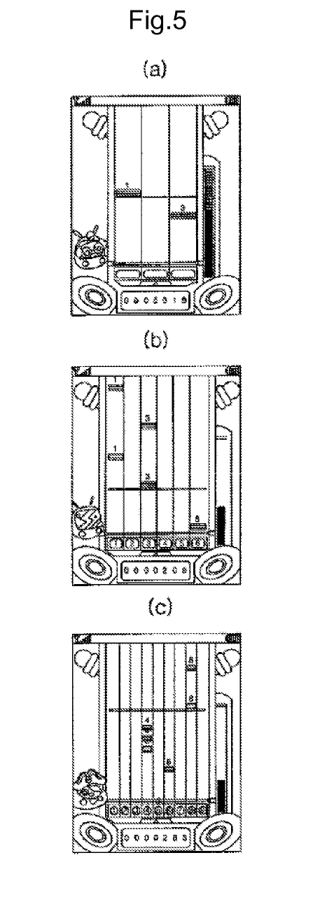

FIG. 5 illustrates examples of note-falling patterns for respective key selection modes in the method of executing a rhythm action game using the terminal equipped with a keypad according to an embodiment of the present invention.

FIG. 5(a) illustrates an exemplary note-falling pattern for EASY mode in which three keys are used. FIG. 5(b) illustrates an exemplary note-falling pattern for HARD mode in which six keys are used. Further, FIG. 5(c) illustrates an exemplary note-falling pattern for CRAZY mode in which nine keys are used.

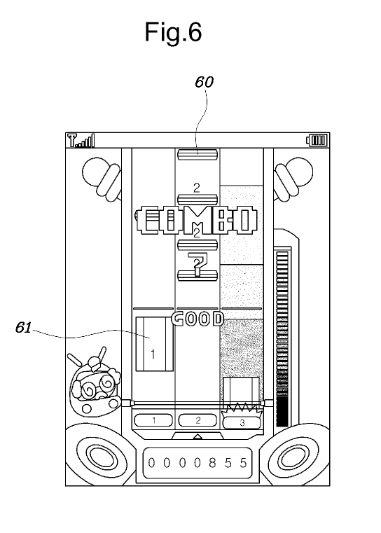

FIG. 6 is a diagram showing the types of note images in the method of executing a rhythm action game using the terminal equipped with a keypad according to an embodiment of the present invention.

Referring to FIG. 6, note images may include a long note 61 as well as normal notes 60. The long note 61 is a note having a shape extending lengthwise in the vertical direction of the screen, compared to the normal notes. The user can play the game by pressing a corresponding key once for each normal note 60, and can play the game by continuously pressing a corresponding key during a period from the time point at which the bottom of the long note 61 meets a reference point to the time point at which the top of the long note 61 meets the reference point, for the long note 61.

The rhythm action game according to the present invention introduces various systems to allow the user to get additional pleasure, as well as pleasure obtained due to the play of the above-described game.

For example, points can be acquired separately from the ability to play the game by a point system. Points can be designated to be obtained when a button is pressed at the exact time for a specific note image among note images output during the play of the game. Further, points obtained in this way may be used to extend game option items such as the speed option, for example, 0.5-speed, 2-speed, and 3-speed, the mirror option, and the random note arrangement option, or may be used to download music.

Such a point system may be operated as a planet recovery system, thus increasing the user's interest. The planet recovery system is a system configured such that when the user exactly hits notes falling together with specific note images, for example, musical note images, while playing the game, those musical notes (points) are collected to recover a planet, and such that the game option corresponding to the recovered planet can be acquired or the score can be increased. The following Table 6 shows various specifications of the planet recovery system.

TABLE 6

| | | | | Number of |
|---|---|---|---|---|
| Number | Planet | Bonus score | Description | musical notes |
| 1 | Sirius | *1.1 | 0.5-speed | 4 |
| 2 | Capella | *1.2 | 2-speed | 4 |
| 3 | Betelgeuse | *1.5 | 4-speed | 9 |
| 4 | Antares | *1.4 | Mirror | 6 |
| 5 | Monocerotis | *1.6 | Random | 7 |
| 6 | Leonis | *1.6 | 0.5-speed & | 9 |
| | | | mirror | |
| 7 | Dourados | *1.75 | 2-speed & | 12 |
| | | | mirror | |
| 8 | La Superba | *2.1 | 3-speed & | 14 |
| | | | mirror | |
| 9 | Cygni | *1.9 | 0.5-speed & | 11 |
| | | | random | |
| 10 | Sagittarius | *2 | 2-speed & | 13 |
| | | | random | |
| 11 | VV Cephei | *2.5 | 3-speed & | 15 |
| | | | random | |

Referring to Table 6, for example, when six musical notes are obtained, one of planets requiring six or less musical notes, for example, Sirius, Capella, and Antares, can be recovered, and a score increment and an option item corresponding to the recovered planet can be acquired.

Then, the present invention allows the user to additionally input option selection information corresponding to the recovery of a planet before step S220 of FIG. 2, for example, at step S215 after music has been selected at step S210. Accordingly, when the user selects an option, a note pattern to which the selected option is applied is output, and thus the game can be provided to the user.

This point system, for example, the planet recovery system makes it possible to provide games with various modes, and to vary the difficulty levels of the game itself, as well as to raise the acquired scores, thus enabling enjoyment to be provided in the form of different sensations according to the application of the planet recovery even if the same music is played.

As another example, a trophy system can be provided. A trophy system is configured such that whenever predefined conditions are satisfied, respective trophies are acquired. This system induces users to communicate with one another, and instills in users the desire to obtain new trophies, thus improving enjoyment when playing the game. Here, conditions for obtaining trophies can be implemented as hidden conditions.

As a further example, a report system can be provided. This report system makes it possible to show the time used to date to play the game, the number of times the game has been played, the number of times the game was finished, the number of pieces of music downloaded, and/or the acquired grade, to the users, thus providing extraordinary interest to users who play the game.

Meanwhile, the rhythm action game according to the present invention is a game for hitting falling notes on the screen in exactly measured time while listening to music. Since the note-falling patterns on the screen are produced based on music data, the game environment of the user can be optimized only when the output of the note images corresponding to note-falling patterns has been synchronized with the speed at which the sound is being played.

However, since mobile or small-sized terminals have lower hardware performance and worse logic performance related to sound power than do high-specification devices such as PCs, the case where sound is output without being synchronized with note images occurs. There may be regarded as being two factors responsible for this, that is, (1) the time it takes sound data to be loaded into a sound chip, and (2) the speed at which sound is played by the sound chip.

First, with regard to (1) the time it takes sound data to be loaded into the sound chip, this time is negligibly small in high-specification hardware, so that sound can be thought of as being output at the moment at which a program commands the output of sound. However, in the case of mobile terminals, a certain period of time is required for sound data to be loaded into the sound chip, and may vary according to the specification of each terminal.

Further, with regard to (2) the speed at which sound is played by the sound chip, this speed can be thought of as being exactly identical to the speed at which the original sound data is played, in the case of high-specification hardware. However, in the case of mobile terminals, the speed at which sound is played by the sound chip may differ from the speed at which the actually produced original sound is played. That is, a phenomenon in which the speed of sound being played becomes gradually faster or slower may occur.

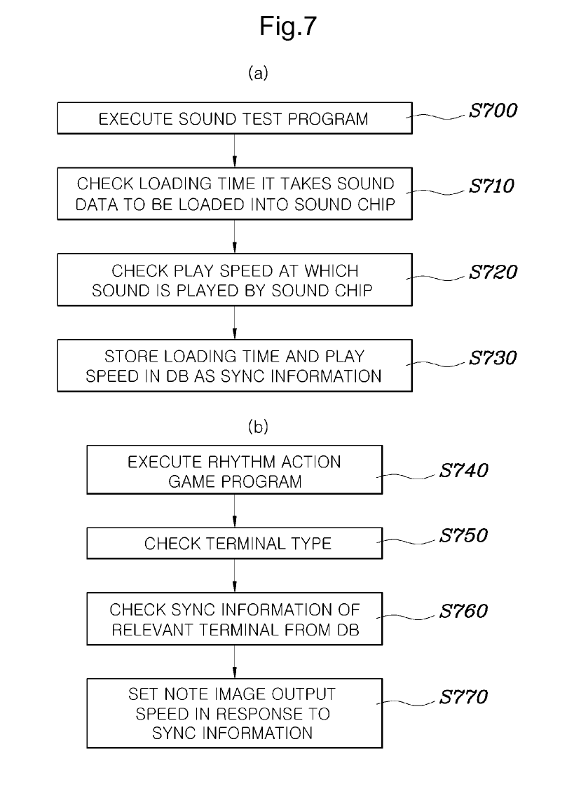

FIG. 7 is a diagram showing a method of synchronizing sound with note images in the method of executing a rhythm action game using the terminal equipped with a keypad according to an embodiment of the present invention.

According to the present embodiment, the synchronization between the play of sound and the output of note images in a mobile terminal can be achieved by a method of measuring from the mobile terminal (1) the time it takes sound data to be loaded into the sound chip and (2) the speed at which sound is played by the sound chip, storing these values in a database (DB), searching the DB for those values before the game is executed, and controlling the measure at which notes are falling on the basis of the values.

Referring to FIG. 7(a), a sound test program is executed on a specific terminal at step S700. This program can be executed on an Operating System (OS) or a platform, sound data can be loaded into the sound chip using functions supported by the OS or the like, and sound can be played by the sound chip. Here, the sound test program may be either an actual game program or a modified program obtained by extracting only a specific code for sound tests.

Then, at step S710, loading time that is the time it takes sound data to be loaded into the sound chip is checked. At step S720, play speed that is the speed at which sound is played by the sound chip is checked. At step S730, the loading time checked at step S710 and the play speed checked at step S720 are stored in the DB as synchronization (sync) information for the above specific terminal.

Meanwhile, there may be a difference among mobile terminals in the execution speed of the game according to the hardware or internal software version, or the frequency of or method of use of the mobile terminal by the user. Therefore, this operation is performed on various terminals, so that sync information for the various terminals may be acquired and stored in the game program, with the result that the game program can be provided.

Referring to FIG. 7(b), at step S740, the game program in which the sync information for various terminals is stored, that is, the rhythm action game according to the present embodiment, is executed. Then, at step S750, the type of the terminal is checked based on the device information about the relevant terminal, and at step S760, the sync information for the relevant terminal, stored in the DB, is checked. At step S770, the output speed of note images is controlled in response to the sync information, thus enabling note images synchronized with music to be output.

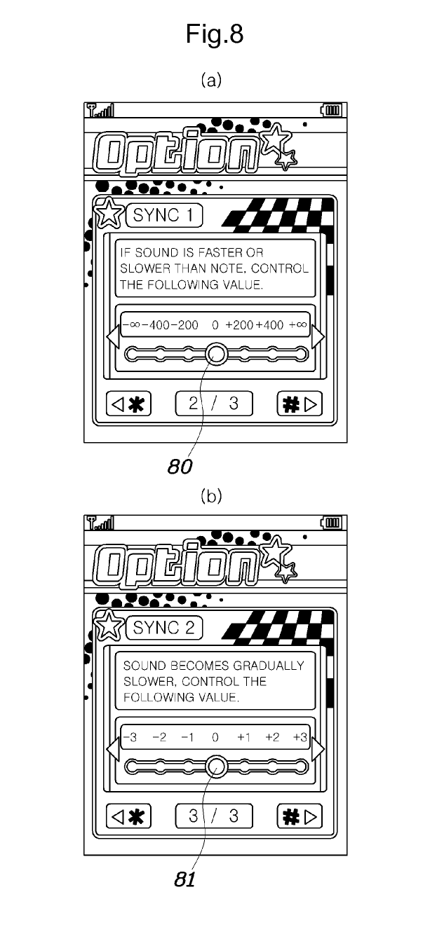

FIG. 8 is a diagram showing a method in which a user synchronizes sound with note images in the method of executing a rhythm action game using the terminal equipped with a keypad according to an embodiment of the present invention.

Fine synchronization may be required even when the output speeds of note images are controlled for each terminal in FIG. 7. According to the present embodiment, the output speed of note images can be controlled through the user interface even by a user.

FIG. 8(a) illustrates a screen on which the user can perform synchronization when sound is not synchronized with the output of note images, and FIG. 8(b) illustrates a screen on which the user can perform synchronization when the speed of sound becomes gradually slower or faster. The user can perform synchronization in such a way as to control the speed to a desired level by moving points 80 and 81 displayed on the respective screens to the left or right.

It is apparent that the present invention can be applied not only to the above-described rhythm action game methods, but also to various implementation forms such as a program capable of executing the rhythm action game, a recording medium for storing the program capable of executing the rhythm action game, and a terminal capable of executing the rhythm action game.

Although the present invention has been described with reference to the drawings and preferred embodiments, those skilled in the art will appreciate that various modifications and changes are possible, without departing from the scope and spirit of the invention as disclosed in the accompanying claims.

### INDUSTRIAL APPLICABILITY

The invention related to the rhythm action game method described in the present specification can be used for games which are executed on mobile terminals each equipped with a keypad. In this case, it is apparent that a mobile terminal equipped with a keypad includes a keypad implemented on a touch screen in the form of an image, as well as a physically implemented keypad.

1. A rhythm action game method using a terminal equipped with a keypad, comprising the steps of:
receiving key selection information required to determine a type and a number of keys that are used when a game is executed and music selection information required to select music that is output when the game is executed;
outputting note images through a display unit of the terminal, together with the selected music, according to a note-falling pattern that is determined based on the key selection information and the music selection information;
receiving information about user responses to the note images input by a user through the keypad;
judging results of note-based games using the user response information; and
outputting the results of the note-based games to the terminal in a form of images and vibrations depending on settings made by the user, and acquiring synchronization information related to the terminal as the game is initially downloaded to the terminal, and synchronizing output of the note images with output of the music using the synchronization information, and the synchronization information comprises information about time it takes sound data to be loaded into a sound chip in the terminal and information about speed at which music is played by the sound chip in the terminal.

2. (canceled)

3. (canceled)

4. The rhythm action game method according to claim 1, wherein the synchronization step is additionally performed depending on settings made by the user after a program is initially downloaded.

5. (canceled)

6. The rhythm action game method according to claim 1, wherein the results of the note-based games are determined based on one or more of accuracy, speed and time of the user response.

7. The rhythm action game method according to claim 1, wherein the note images are output together with one of key information related to the note images and specific note image information.

8. The rhythm action game method according to claim 1, wherein the note images include a normal note and a long note.

9. The rhythm action game method according to claim 1, wherein the note images are output at a speed of 10 to 20 frames per sec.

10. The rhythm action game method according to claim 1, further comprising the step of receiving option selection information related to one or more of a plurality of option selection items which include a speed option and a note arrangement option, wherein the option selection items are determined depending on points acquired in relation to notes output together with a specific note image while the user is playing the game.

11. A computer-readable recording medium for storing a program for executing the method according to claim 1.

12. A computer-readable recording medium for storing a program for executing the method according to claim 4.

13. A computer-readable recording medium for storing a program for executing the method according to claim 6.

14. A computer-readable recording medium for storing a program for executing the method according to claim 7.

15. A computer-readable recording medium for storing a program for executing the method according to claim 8.

16. A computer-readable recording medium for storing a program for executing the method according to claim 9.

17. A computer-readable recording medium for storing a program for executing the method according to claim 10.
